(19) United States
(12) Patent Application Publication
(10) Pub. No.: US 2025/0211972 A1
(43) Pub. Date: Jun. 26, 2025

(54) REPORTING METHOD/APPARATUS/DEVICE AND STORAGE MEDIUM

(71) Applicant: Beijing Xiaomi Mobile Software Co., Ltd., Beijing (CN)

(72) Inventor: Dong CHEN, Beijing (CN)

(73) Assignee: Beijing Xiaomi Mobile Software Co., Ltd., Beijing (CN)

(21) Appl. No.: 18/849,960

(22) PCT Filed: Mar. 23, 2022
(86) PCT No.: PCT/CN2022/082588

§ 371 Date: Sep. 23, 2024

(51) Int. Cl. H04W 8/22

(52) U.S. Cl. CPC H04W 8/22

(57) ABSTRACT

A reporting method, system computer readable medium for enabling communication with a network device to share computing capabilities. The method involves acquiring a capability request message from the network device and reporting capability information, This solution facilitates efficient sharing and management of the UE's computing resources with network devices, enhancing overall network resource utilization and computational efficiency.

### CROSS-REFERENCE TO RELATED APPLICATIONS

This application is a national stage of International Application No. PCT/CN2022/082588, filed on Mar. 23, 2022, which is hereby incorporated by reference in its entirety.

### TECHNICAL FIELD

The present disclosure relates to the field of communication technologies, and in particular, to a reporting method and apparatus, a device and a storage medium.

### BACKGROUND

In a communication system, computing capability of a network device or a user equipment (UE) usually needs to be shared for use by other terminals, so as to achieve a purpose of “maximizing resource utilization, improving computing efficiency, and reducing computing cost”.

In related arts, computing capability of a UE may be shared to a network device or another terminal. Still, in related arts, the network device may not know whether the UE supports a computing capability sharing function. Hence, it cannot perform related configurations on the UE, which may cause a failure in providing computing capability to the network device or another terminal.

### SUMMARY

According to a reporting method and apparatus, a device and a storage medium provided by the present disclosure, a UE reports to a network device whether the UE supports a computing capability sharing function, to solve a technical problem that “the network device does not know whether the UE supports the computing capability sharing function, causing that the UE cannot provide computing capability to the network device and other terminals”.

An aspect of embodiments of the present disclosure provides a method, performed by a UE, including:
acquiring a capability request message sent by a network device; and
reporting capability information to the network device, where the capability information includes at least one of:
first indication information indicating whether the UE supports a computing capability sharing function;
second indication information indicating whether the UE enables a computing capability sharing function; or
a computing capability parameter of the UE.

Optionally, in an embodiment of the present disclosure, the computing capability parameter of the UE includes at least one of:
a base clock speed of a computing unit of the UE;
a cache of a computing unit of the UE;
a core count of a computing unit of the UE;
a bus speed of a computing unit of the UE; or
a ratio of sharable computing capability to total computing capability of the UE.

Optionally, in an embodiment of the present disclosure, acquiring the capability request message sent by the network device includes:
acquiring a UE Capability Enquiry message sent by the network device.

Optionally, in an embodiment of the present disclosure, reporting the capability information to the network device includes:
reporting UE Capability information to the network device.

Optionally, in an embodiment of the present disclosure, the method further includes:
acquiring an enquiry request message sent by the network device, where the enquiry request message includes at least one of:
first enquiry information enquiring whether computing capability of the UE is available to be shared to the network device; or
second enquiry information enquiring a time when computing capability of the UE is available to be shared to the network device.

Optionally, in an embodiment of the present disclosure, acquiring the enquiry request message sent by the network device includes:
acquiring a UE Information Request message sent by the network device.

Optionally, in an embodiment of the present disclosure, the method further includes:
sending a response message to the network device; where the response message includes at least one of:
a third indication information indicating whether the computing capability of the UE is available to be shared to the network device; or
time information indicating the time when the computing capability of the UE is available to be shared to the network device.

Optionally, in an embodiment of the present disclosure, sending the response message to the network device includes:
sending the response message to the network device based on a computing task of the UE.

Optionally, in an embodiment of the present disclosure, sending the response message to the network device includes:
sending a UE Information Response message to the network device.

Another aspect of embodiments of the present disclosure provides a method, performed by a network device, including:
sending a capability request message to a user equipment (UE); and
acquiring capability information reported by the UE, where the capability information includes at least one of:
first indication information indicating whether the UE supports a computing capability sharing function;
second indication information indicating whether the UE enables a computing capability sharing function; or
a computing capability parameter of the UE.

Optionally, in an embodiment of the present disclosure, the computing capability parameter of the UE includes at least one of:
a base clock speed of a computing unit of the UE;
a cache of a computing unit of the UE;
a core count of a computing unit of the UE;
a bus speed of a computing unit of the UE; or
a ratio of sharable computing capability to total computing capability of the UE.

Optionally, in an embodiment of the present disclosure, sending the capability request message to the UE includes:
sending a UE Capability Enquiry message to the UE.

Optionally, in an embodiment of the present disclosure, acquiring the capability information reported by the UE includes:
acquiring UE Capability Information reported by the UE.

Optionally, in an embodiment of the present disclosure, the method further includes:
sending an enquiry request message to the UE, where the enquiry request message includes at least one of:
first enquiry information enquiring whether computing capability of the UE is available to be shared to the network device; or
second enquiry information enquiring a time when computing capability of the UE is available to be shared to the network device.

Optionally, in an embodiment of the present disclosure, sending the enquiry request message to the UE includes:
sending a UE Information Request message to the UE.

Optionally, in an embodiment of the present disclosure, the method further includes:
acquiring a response message sent by the UE, where the response message includes at least one of:
a third indication information indicating whether the computing capability of the UE is available to be shared to the network device; or
time information indicating the time when the computing capability of the UE is available to be shared to the network device.

Optionally, in an embodiment of the present disclosure, acquiring the response message sent by the UE includes:
acquiring a UE Information Response message sent by the UE.

Optionally, in an embodiment of the present disclosure, the method further includes:
using the computing capability of the UE when the computing capability of the UE is available to be shared to the network device.

Another aspect of embodiments of the present disclosure provides a reporting apparatus, including:
an acquiring module, configured to acquire a capability request message sent by a network device; and
a reporting module, configured to report capability information to the network device, where the capability information includes at least one of:
first indication information indicating whether the UE supports a computing capability sharing function;
second indication information indicating whether the UE enables a computing capability sharing function; or
a computing capability parameter of the UE.

Another aspect of embodiments of the present disclosure provides a reporting apparatus, including:
a sending module, configured to send a capability request message to a UE; and
an acquiring module, configured to acquire capability information reported by the UE, where the capability information includes at least one of:
first indication information indicating whether the UE supports a computing capability sharing function;
second indication information indicating whether the UE enables a computing capability sharing function; or
a computing capability parameter of the UE.

Another aspect of embodiments of the present disclosure provides a communication device, including a processor and a memory, where the memory stores a computer program, and the processor executes the computer program stored in the memory to cause the device to perform the method according to above aspect of embodiments.

Another aspect of embodiments of the present disclosure provides a communication device, including a processor and a memory, where the memory stores a computer program, and the processor executes the computer program stored in the memory to cause the device to perform the method according to above another aspect of embodiments.

Another aspect of embodiments of the present disclosure provides a communication device, including: a processor and an interface circuit;
the interface circuit is configured to receive a code instruction and transmit the code instruction to the processor;
the processor is configured to execute the code instruction to perform the method according to the above aspect of embodiments.

Another aspect of embodiments of the present disclosure provides a communication device, including: a processor and an interface circuit;
the interface circuit is configured to receive a code instruction and transmit the code instruction to the processor;
the processor is configured to execute the code instruction to perform the method according to the above another aspect of embodiments.

Another aspect of embodiments of the present disclosure provides a computer-readable storage medium, configured to store an instruction, and when the instruction is executed, the method according to the above aspect of embodiments is implemented.

Another aspect of embodiments of the present disclosure provides a computer-readable storage medium, configured to store an instruction, and when the instruction is executed, the method according to the above another aspect of embodiments is implemented.

As described above, according to the reporting method and apparatus, the device and the storage medium provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

### BRIEF DESCRIPTION OF DRAWINGS

The above and/or additional aspects and advantages of the present disclosure will become apparent and readily understood from the following description of embodiments taken in reference with the accompanying drawings.

FIG. 1 is a schematic flowchart of a reporting method according to an embodiment of the present disclosure.

FIG. 2 is a schematic flowchart of a reporting method according to another embodiment of the present disclosure.

FIG. 3 is a schematic flowchart of a reporting method according to another embodiment of the present disclosure.

FIG. 4 is a schematic flowchart of a reporting method according to another embodiment of the present disclosure.

FIG. 5 is a schematic flowchart of a reporting method according to another embodiment of the present disclosure.

FIG. 6 is a schematic flowchart of a reporting method according to another embodiment of the present disclosure.

FIG. 7A is a schematic flowchart of a reporting method according to another embodiment of the present disclosure.

FIG. 7B is a schematic flowchart of a reporting method according to another embodiment of the present disclosure.

FIG. 8 is a schematic flowchart of a reporting method according to another embodiment of the present disclosure.

FIG. 9 is a schematic structural diagram of a reporting apparatus according to an embodiment of the present disclosure.

FIG. 10 is a schematic structural diagram of a reporting apparatus according to another embodiment of the present disclosure.

FIG. 11 is a block diagram of a user equipment according to an embodiment of the present disclosure.

FIG. 12 is a block diagram of a network device according to an embodiment of the present disclosure.

### DETAILED DESCRIPTION

Example embodiments will be described in detail herein, examples of which are illustrated in the accompanying drawings. When the following description refers to the drawings, unless otherwise indicated, same numerals in different drawings indicate same or similar elements. The implementations described in the following example embodiments do not represent all implementations consistent with the embodiments of the present disclosure. Rather, they are merely examples of apparatuses and methods consistent with some aspects of embodiments of the present disclosure as detailed in the appended claims.

The terminology used in the embodiments of the present disclosure is merely for the purpose of describing specific embodiments, and is not intended to limit the embodiments of the present disclosure. Singular forms “a” and “the” used in the embodiments of the present disclosure and the appended claims are also intended to include plural forms unless the context clearly indicates other meanings. It should also be understood that the term “and/or” as used herein refers to and encompasses any or all possible combinations of one or more associated listed items.

It should be understood that although the terms “first,” “second,” “third,” etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information,” and similarly, “second information” may also be referred to as “first information”. Depending on context, the words “if”' and “when” as used herein may be interpreted as “upon” or “in a case that” or “in response to determining”.

The reporting method and apparatus, the device and the storage medium provided by the embodiments of the present disclosure will be described in detail below with reference to the accompanying drawings.

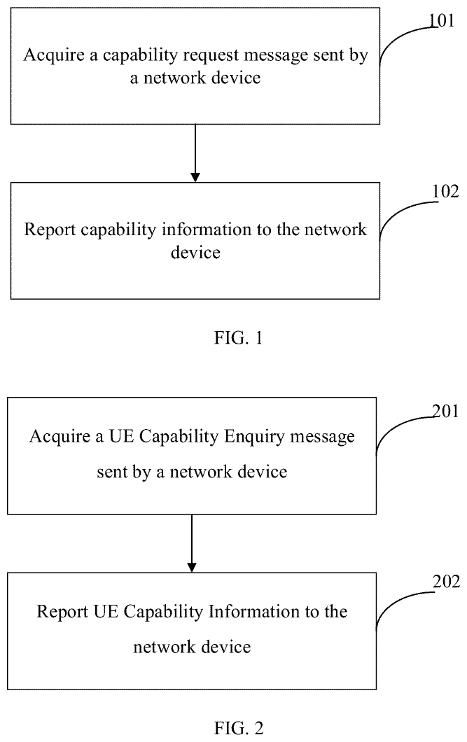

FIG. 1 is a schematic flowchart of a reporting method according to an embodiment of the present disclosure, the method is performed by a UE, and as shown in FIG. 1, the reporting method may include following steps.
Step 101, acquiring a capability request message sent by a network device.

It should be noted that the method in the embodiments of the present disclosure may be applicable to a 5G (5th Generation) communication system, and is also applicable to a next-generation (or next generations) mobile communication system.

In addition, in an embodiment of the present disclosure, the UE may include a device that provides voice and/or data connectivity to the user. The terminal device may communicate with one or more core networks through a radio access network (RAN), and the UE may be an Internet of Things terminal, such as a sensor device, a mobile phone (or referred to as a “cellular” phone), and a computer having the Internet of Things terminal, for example, may be a fixed, portable, pocket, handheld, computer built-in, or vehicle-mounted apparatus. For example, a station (STA), a subscriber unit, a subscriber station, a mobile station, a mobile, a remote station, an access point, a remote terminal, an access terminal, a user terminal, or a user agent. Alternatively, the UE may include an unmanned aerial vehicle device. Alternatively, the UE may include a vehicle-mounted device, for example, a vehicle computer having a wireless communication function, or a wireless terminal externally connected to a vehicle computer. Alternatively, the UE may include a roadside device, for example, a street lamp, a signal light, or another roadside device having a wireless communication function.

In an embodiment of the present disclosure, the capability request message may be used by the network device to request the UE to report related information of the computing capability sharing function of the UE, and in an embodiment of the present disclosure, the capability request message may be a UE Capability Enquiry message.
Step 102, reporting capability information to the network device.

In an embodiment of the present disclosure, the capability information may include at least one of:
first indication information indicating whether the UE supports a computing capability sharing function;
second indication information indicating whether the UE enables a computing capability sharing function; or
a computing capability parameter of the UE.

In an embodiment of the present disclosure, the first indication information may be an N-bit indication code, where N is a positive integer. For example, in an embodiment of the present disclosure, the first indication information may be a 1-bit indication code, and when the first indication information is a first value (e.g., 1), the first indication information indicates that the UE supports the computing capability sharing function, and when the first indication information is a second value (e.g., 0), the first indication information indicates that the UE does not support the computing capability sharing function.

In an embodiment of the present disclosure, the second indication information may be an M-bit indication code, where M is a positive integer, and M is equal to or unequal to N. For example, in an embodiment of the present disclosure, the second indication information may be a 1-bit indication code, and when the second indication information is a first value (e.g., 1), the second indication information indicates that the UE enables the computing capability sharing function, and when the second indication information is a second value (e.g., 0), the second indication information indicates that the UE does not enable the computing capability sharing function.

In an embodiment of the present disclosure, the computing capability parameter of the UE may include at least one of:
a base clock speed of a computing unit of the UE;
a cache of a computing unit of the UE;
a core count of a computing unit of the UE;
a bus speed of a computing unit of the UE; or
a ratio of sharable computing capability to total computing capability of the UE.

It should be noted that, in an embodiment of the present disclosure, the capability information may include only the first indication information. In another embodiment of the present disclosure, when the first indication information in the capability information indicates that the UE supports the computing capability sharing function, the capability information may further include the second indication information. In another embodiment of the present disclosure, when the first indication information in the capability information indicates that the UE supports the computing capability sharing function, and the second indication information indicates that the UE enables the computing capability sharing function, the capability information may further include the computing capability parameter of the UE.

Further, in an embodiment of the present disclosure, the capability information may be UE Capability Information.

Specifically, in an embodiment of the present disclosure, when the UE reports the first indication information to the network device through the UE Capability Information, the UE may use one or more bits as the first indication information in the UE Capability Information to indicate whether the UE supports the computing capability sharing function; and when the UE reports the second indication information to the network device through the UE Capability Information, the UE may also use one or more bits as the second indication information in the UE Capability Information to indicate whether the UE enables the computing capability sharing function.

In addition, in an embodiment of the present disclosure, after the UE reports the capability information to the network device, the network device may perform related configuration of computing capability sharing on the UE based on the capability information to share the computing capability of the UE.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

FIG. 2 is a schematic flowchart of a reporting method according to an embodiment of the present disclosure, the method is performed by a UE, and as shown in FIG. 2, the reporting method may include following steps.
Step 201, acquiring a UE Capability Enquiry message sent by a network device.
Step 202, reporting UE Capability Information to the network device.

In an embodiment of the present disclosure, the UE Capability Information may include at least one of:
first indication information indicating whether the UE supports a computing capability sharing function;
second indication information indicating whether the UE enables a computing capability sharing function; or
a computing capability parameter of the UE.

In an embodiment of the present disclosure, a transmission process of the UE Capability Enquiry message and the UE Capability Information may be determined based on the 3GPP specification 38.331.

For other detailed descriptions of steps 301 and 302, reference may be made to the descriptions of the above embodiments, and details will not be repeated here in the embodiment of the present disclosure.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

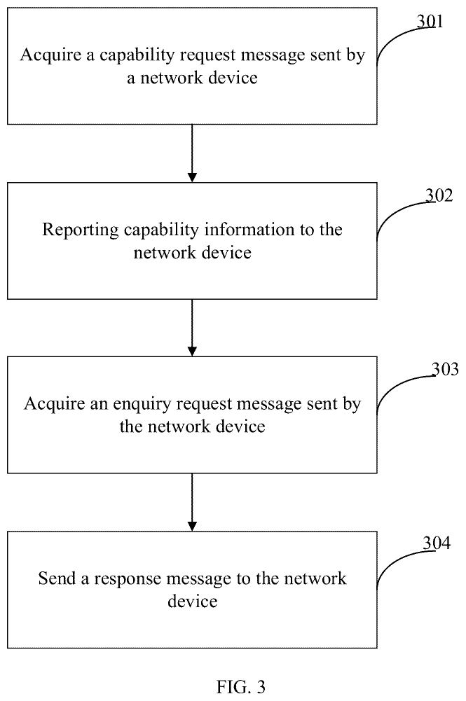

FIG. 3 is a schematic flowchart of a reporting method according to an embodiment of the present disclosure, the method is performed by a UE, and as shown in FIG. 3, the reporting method may include following steps.
Step 301, acquiring a capability request message sent by a network device.
Step 302, reporting capability information to the network device.

For descriptions of step 301-302, reference may be made to the description of the above embodiments, and details are not be repeated here in the embodiment of the present disclosure.
Step 303, acquiring an enquiry request message sent by the network device.

In an embodiment of the present disclosure, before computing capability sharing, an enquiry request message sent by the network device is obtained, where the enquiry request message may include at least one of:
first enquiry information enquiring whether computing capability of the UE is available to be shared to the network device; or
second enquiry information enquiring a time when computing capability of the UE is available to be shared to the network device.

It should be noted that, in an embodiment of the present disclosure, when the first indication information in the capability information indicates that the UE supports the computing capability sharing function, and the second indication information indicates that the UE enables the computing capability sharing function, it indicates that the UE currently supports sharing the computing capability to the network device. However, since the UE also has a computing task of its own, the UE also needs a certain computing capability, and if the computing task of the UE are relatively complex, even if the UE supports sharing the computing capability to the network device, to ensure accurate execution of the computing task of the UE, the UE may not allow the network device to share the computing capability of the UE. Based on this, before the network device needs to share the computing capability of the UE, the network device further needs to send an enquiry request message to the UE, to enquiry whether the computing capability of the UE is available to be shared to the network device and/or enquiry a time when the computing capability of the UE is available to be shared to the network device.

In an embodiment of the present disclosure, the enquiry request message may be a UE Information Request message.
Step 304, sending a response message to the network device.

In an embodiment of the present disclosure, the response message includes at least one of:
a third indication information indicating whether the computing capability of the UE is available to be shared to the network device; or
time information indicating the time when the computing capability of the UE is available to be shared to the network device.

In addition, in an embodiment of the present disclosure, specifically, the UE may send the response message to the network device based on the computing task of the UE.

Specifically, in an embodiment of the present disclosure, when the UE currently has a computing task and the current computing task is complex, the UE currently requires high computing capability, and at this time, if the UE shares the computing capability to the network device, accurate execution of the current computing task of the UE may be affected, the response message sent by the UE to the network device may include a third indication information indicating that the computing capability of the UE is not available to be shared to the network device.

In another embodiment of the present disclosure, when the UE currently has a computing task and the current computing task is simple, the UE currently requires low computing capability, and the UE may share a part of the computing capability to the network device, and at this time, the response message sent by the UE to the network device may include a third indication information indicating that the computing capability of the UE is available to be shared to the network device, and time information indicating the time when the computing capability of the UE is available to be shared to the network device, where the time indicated by the time information may be short.

In still another embodiment of the present disclosure, when the UE does not currently have a computing task, the UE does not require any computing capability, and the UE may share most or all of the computing capability to the network device, in this case, the response message sent by the UE to the network device may include a third indication information indicating that the computing capability of the UE is available to be shared to the network device, and time information indicating the time when the computing capability of the UE is available to be shared to the network device, where the time indicated by the time information may be long.

Further, in an embodiment of the present disclosure, the third indication information may be an F-bit indication code, where F is a positive integer. For example, in an embodiment of the present disclosure, the third indication information may be a 1-bit indication code, and when the third indication information is a first value (e.g., 1), the third indication information indicates that the computing capability of the UE is available to be shared by the network device, and when the third indication information is a second value (e.g., 2), the third indication information indicates that the computing capability of the UE is not available to be shared to the network device.

In addition, in an embodiment of the present disclosure, the response message may include a UE Information Response message.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

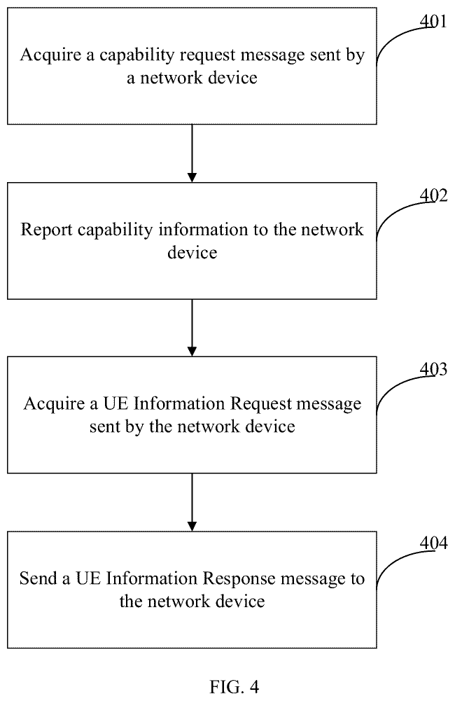

FIG. 4 is a schematic flowchart of a reporting method according to an embodiment of the present disclosure, the method is performed by a UE, and as shown in FIG. 4, the reporting method may include following steps.
Step 401, acquiring a capability request message sent by a network device.
Step 402, reporting capability information to the network device.
Step 403, acquiring a UE Information Request message sent by the network device.
Step 404, sending a UE Information Response message to the network device.

In an embodiment of the present disclosure, a transmission process of the UE Information Request message and the UE Information Response message may be determined based on the 3GPP specification 38.331.

For other detailed descriptions of steps 401-404, reference may be made to the descriptions of the above embodiments, and details will not be repeated here in the embodiments of the present disclosure.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

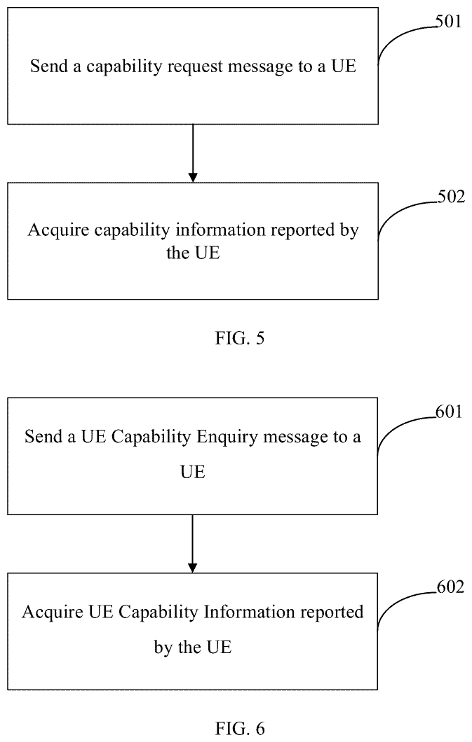

FIG. 5 is a schematic flowchart of a reporting method according to an embodiment of the present disclosure, the method is performed by a network device, and as shown in FIG. 5, the reporting method may include following steps.
Step 501, sending a capability request message to a user equipment (UE).
Step 502, acquiring capability information reported by the UE.

In an embodiment of the present disclosure, the capability information may include at least one of:
first indication information indicating whether the UE supports a computing capability sharing function;
second indication information indicating whether the UE enables a computing capability sharing function; or
a computing capability parameter of the UE.

In an embodiment of the present disclosure, the computing capability parameter of the UE may include at least one of:
a base clock speed of a computing unit of the UE;
a cache of a computing unit of the UE;
a core count of a computing unit of the UE;
a bus speed of a computing unit of the UE; or
a ratio of sharable computing capability to total computing capability of the UE.

For other detailed descriptions of steps 501 and 502, reference may be made to the descriptions of the above embodiments, and details will not be repeated here in the embodiment of the present disclosure.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

FIG. 6 is a schematic flowchart of a reporting method according to an embodiment of the present disclosure, the method is performed by a UE, and as shown in FIG. 6, the reporting method may include following steps.
Step 601, sending a UE Capability Enquiry message to a UE.
Step 602, acquiring UE Capability Information reported by the UE.

For other detailed descriptions of steps 601 and 602, reference may be made to the descriptions of the above embodiments, and details will not be repeated here in the embodiment of the present disclosure.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

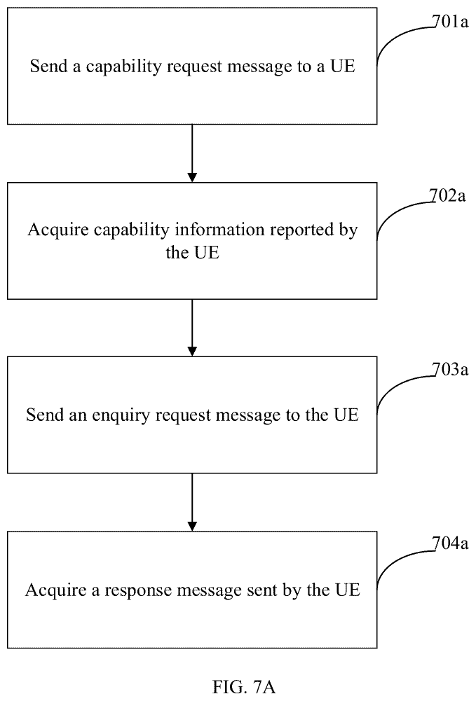

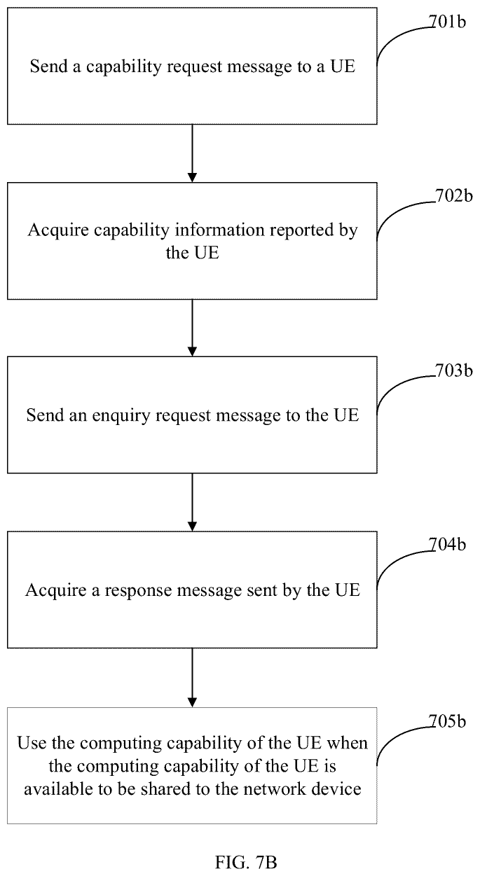

FIG. 7A is a schematic flowchart of a reporting method according to an embodiment of the present disclosure, the method is performed by a network device, and as shown in FIG. 7A, the reporting method may include following steps.
Step 701a: sending a capability request message to a UE.
Step 702a: acquiring capability information reported by the UE.
Step 703a: sending an enquiry request message to the UE.

In an embodiment of the present disclosure, the enquiry request message includes at least one of:
first enquiry information enquiring whether computing capability of the UE is available to be shared to the network device; or
second enquiry information enquiring a time when computing capability of the UE is available to be shared to the network device.
Step 704a: acquiring a response message sent by the UE.

In an embodiment of the present disclosure, the response message includes at least one of:
a third indication information indicating whether the computing capability of the UE is available to be shared to the network device; or
time information indicating the time when the computing capability of the UE is available to be shared to the network device.

For other detailed descriptions of steps 701a-704a, reference may be made to the descriptions of the above embodiments, and details will not be repeated here in the embodiment of the present disclosure.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

FIG. 7B is a schematic flowchart of a reporting method according to an embodiment of the present disclosure, the method is performed by a network device, and as shown in FIG. 7B, the reporting method may include following steps.
Step 701b, sending a capability request message to a UE.
Step 702b, acquiring capability information reported by the UE.
Step 703b: sending an enquiry request message to the UE.

In an embodiment of the present disclosure, the enquiry request message includes at least one of:
first enquiry information enquiring whether computing capability of the UE is available to be shared to the network device; or
second enquiry information enquiring a time when computing capability of the UE is available to be shared to the network device.
Step 704b, acquiring a response message sent by the UE.

In an embodiment of the present disclosure, the response message includes at least one of:
a third indication information indicating whether the computing capability of the UE is available to be shared to the network device; or
time information indicating the time when the computing capability of the UE is available to be shared to the network device.
Step 705b, using the computing capability of the UE when the computing capability of the UE is available to be shared to the network device.

It should be noted that, in an embodiment of the present disclosure, based on step 704b, when the network device acquires the response message sent by the UE, that is, the third indication information indicating whether the computing capability of the UE is available to be shared with the network device, and the third indication information indicates that the computing capability of the UE is available to be shared to the network device, step 705b is performed, that is, the network device can use the computing capability of the UE.

Other detailed descriptions of steps 701b-705b may be referred from the descriptions of the above embodiments, and details will not be repeated here in the embodiment of the present disclosure.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

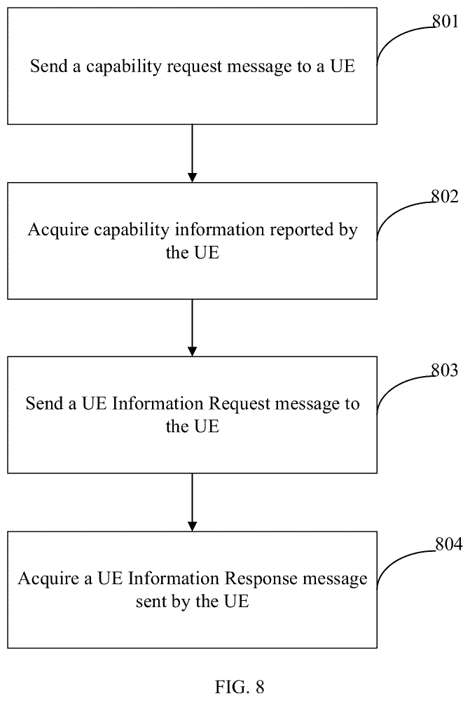

FIG. 8 is a schematic flowchart of a reporting method according to an embodiment of the present disclosure, the method is performed by a network device, and as shown in FIG. 8, the reporting method may include following steps.
Step 801, sending a capability request message to a UE.
Step 802, acquiring capability information reported by the UE.
Step 803, sending a UE Information Request message to the UE.
Step 804, acquiring a UE Information Response message sent by the UE.

As described above, according to the reporting method provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

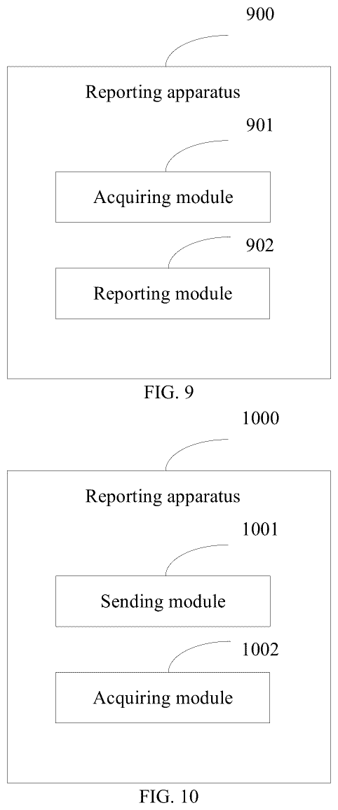

FIG. 9 is a schematic structural diagram of a reporting apparatus according to an embodiment of the present disclosure. As shown in FIG. 9, the apparatus may include:
an acquiring module, configured to acquire a capability request message sent by a network device; and
a reporting module, configured to report capability information to the network device, where the capability information includes at least one of:
first indication information indicating whether the UE supports a computing capability sharing function;
second indication information indicating whether the UE enables a computing capability sharing function; or
a computing capability parameter of the UE.

As described above, according to the reporting apparatus provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.

Optionally, in an embodiment of the present disclosure, the computing capability parameter of the UE includes at least one of:
a base clock speed of a computing unit of the UE;
a cache of a computing unit of the UE;
a core count of a computing unit of the UE;
a bus speed of a computing unit of the UE; or
a ratio of sharable computing capability to total computing capability of the UE.

Optionally, in an embodiment of the present disclosure, the acquiring module is further configured to:
acquire a UE Capability Enquiry message sent by the network device.

Optionally, in an embodiment of the present disclosure, the reporting module is further configured to:
report UE Capability information to the network device.

Optionally, in an embodiment of the present disclosure, the apparatus is further configured to:
acquire an enquiry request message sent by the network device, where the enquiry request message includes at least one of:
first enquiry information enquiring whether computing capability of the UE is available to be shared to the network device; or
second enquiry information enquiring a time when computing capability of the UE is available to be shared to the network device.

Optionally, in an embodiment of the present disclosure, the acquiring module is further configured to:
acquire a UE Information Request message sent by the network device.

Optionally, in an embodiment of the present disclosure, the apparatus is further configured to:
send a response message to the network device; where the response message includes at least one of:
a third indication information indicating whether the computing capability of the UE is available to be shared to the network device; or
time information indicating the time when the computing capability of the UE is available to be shared to the network device.

Optionally, in an embodiment of the present disclosure, the apparatus is further configured to:
send the response message to the network device based on a computing task of the UE.

Optionally, in an embodiment of the present disclosure, the apparatus is further configured to:
send a UE Information Request message to the UE.

FIG. 10 is a schematic structural diagram of a reporting apparatus according to an embodiment of the present disclosure. As shown in FIG. 10, the apparatus may include:
a sending module, configured to send a capability request message to a UE; and
an acquiring module, configured to acquire capability information reported by the UE, where the capability information includes at least one of:
first indication information indicating whether the UE supports a computing capability sharing function;
second indication information indicating whether the UE enables a computing capability sharing function; or

As described above, according to the reporting apparatus provided in the embodiments of the present disclosure, the UE may acquire the capability request message sent by the network device, and then the UE may report the capability information to the network device, where the capability information may include at least one of the first indication information indicating whether the UE supports the computing capability sharing function, the second indication information indicating whether the UE enables the computing capability sharing function, or the computing capability parameter of the UE. As can be seen, in the embodiments of the present disclosure, the UE may report the capability information to the network device, to notify the network device whether the UE supports computing capability sharing, whether the UE enables the computing capability sharing function, and the computing capability parameter of the UE, and the network device may share the computing capability of the UE based on the capability information reported by the UE, thereby maximizing resource utilization, improving computing efficiency, and reducing computing costs.
a computing capability parameter of the UE.

Optionally, in an embodiment of the present disclosure, the computing capability parameter of the UE includes at least one of:
a base clock speed of a computing unit of the UE;
a cache of a computing unit of the UE;
a core count of a computing unit of the UE;
a bus speed of a computing unit of the UE; or
a ratio of sharable computing capability to total computing capability of the UE.

Optionally, in an embodiment of the present disclosure, the sending module is further configured to:
send a UE Capability Enquiry message to the UE.

Optionally, in an embodiment of the present disclosure, the acquiring module is further configured to:
acquire UE Capability Information reported by the UE.

Optionally, in an embodiment of the present disclosure, the apparatus is further configured to:
send an enquiry request message to the UE, where the enquiry request message includes at least one of:
first enquiry information enquiring whether computing capability of the UE is available to be shared to the network device; or
second enquiry information enquiring a time when computing capability of the UE is available to be shared to the network device.

Optionally, in an embodiment of the present disclosure, the apparatus is further configured to:
send a UE Information Request message to the UE.

Optionally, in an embodiment of the present disclosure, the apparatus is further configured to:
acquire a response message sent by the UE, where the response message includes at least one of:
a third indication information indicating whether the computing capability of the UE is available to be shared to the network device; or
time information indicating the time when the computing capability of the UE is available to be shared to the network device.

Optionally, in an embodiment of the present disclosure, the apparatus is further configured to:
acquire a UE Information Response message sent by the UE.

Optionally, in an embodiment of the present disclosure, the apparatus is further configured to:
use the computing capability of the UE when the computing capability of the UE is available to be shared to the network device.

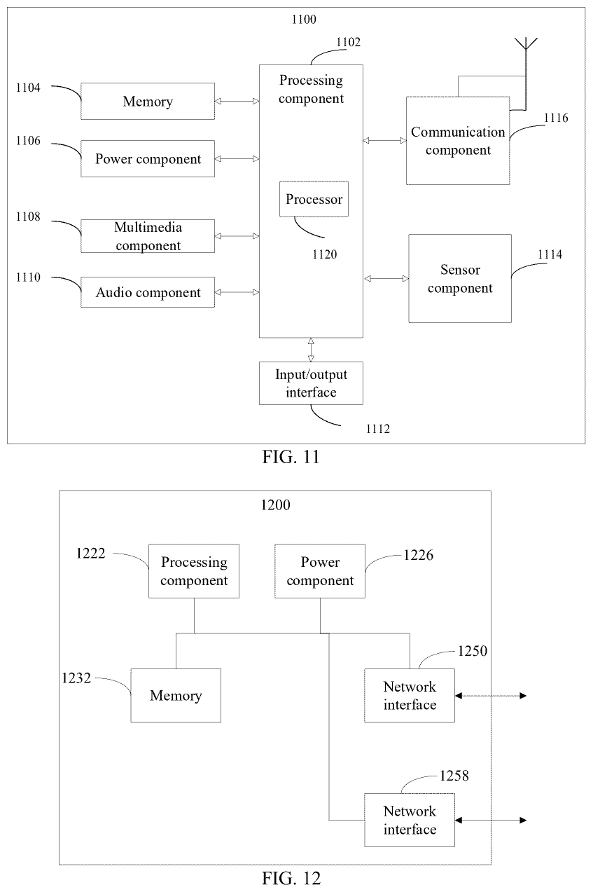

FIG. 11 is a block diagram of a user equipment UE 1100 according to an embodiment of the present disclosure. For example, the UE1100 may include a mobile phone, a computer, a digital broadcast terminal device, a messaging device, a game console, a tablet device, a medical device, a fitness device, a personal digital assistant, or the like.

Referring to FIG. 11, the UE1100 may include at least one of following components: a processing component 1102, a memory 1104, a power component 1106, a multimedia component 1108, an audio component 1110, an input/output (I/O) interface 1112, a sensor component 1113, and a communication component 1116.

The processing component 1102 typically controls the overall operations of the UE1100, such as operations associated with display, telephone calls, data communications, camera operations, and recording operations. The processing component 1102 may include at least one processor 1120 to execute instructions to perform all or part of the steps of the above method. In addition, the processing component 1102 may include at least one module, to facilitate interaction between the processing component 1102 and other components. For example, the processing component 1102 may include a multimedia module to facilitate interaction between the multimedia component 1108 and the processing component 1102.

The memory 1104 is configured to store various types of data to support operations at the UE1100. Examples of such data include instructions for any application or method operating on the UE1100, contact data, phonebook data, messages, pictures, videos, etc. The memory 1104 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 1106 provides power to various components of the UE1100. The power component 1106 may include a power management system, at least one power source, and other components associated with generating, managing, and distributing power for the UE1100.

The multimedia component 1108 includes a screen providing an output interface between the UE1100 and the user. In some embodiments, the screen may include a liquid crystal display (LCD) and a touch panel (TP). If the screen includes the touch panel, the screen may be implemented as a touch screen to receive input signals from a user. The touch panel includes at least one touch sensor to sense touches, swipes, and gestures on the touch panel. The touch sensor may not only sense a boundary of a touch or swipe action, but also detect a wake-up time and pressure associated with the touch or swipe operation. In some embodiments, the multimedia component 1108 includes a front camera and/or a rear camera. When the UE1100 is in an operation mode, such as a shooting mode or a video mode, the front camera and/or the rear camera may receive external multimedia data. Each of the front camera and the rear camera may be a fixed optical lens system or have focal length and optical zoom capability.

The audio component 1110 is configured to output and/or input audio signals. For example, the audio component 1110 includes a microphone (MIC) configured to receive an external audio signal when the UE1100 is in an operation mode, such as a call mode, a recording mode, and a voice recognition mode. The received audio signal may be further stored in the memory 1104 or transmitted via the communication component 1116. In some embodiments, the audio component 1110 further includes a speaker configured to output an audio signal.

The I/O interface 1112 provides an interface between the processing component 1102 and peripheral interface modules, which may be keyboards, click wheels, buttons, etc. These buttons may include, but are not limited to, home buttons, volume buttons, start buttons, and lock buttons.

The sensor component 1113 includes at least one sensor for providing status assessments of various aspects for the UE1100. For example, the sensor component 1113 may detect an open/closed state of the UE1100, relative positioning of components, such as a display and a keypad of the UE1100, a change in position of the UE1100 or a component of the UE1100, a presence or absence of user contact with the UE1100, an orientation or acceleration/deceleration of the UE1100, and a change in temperature of the UE1100. The sensor component 1113 may include a proximity sensor configured to detect the presence of nearby objects without any physical contact. The sensor component 1113 may also include a light sensor, such as a CMOS or CCD image sensor, for use in imaging applications. In some embodiments, the sensor component 1113 may further include an acceleration sensor, a gyroscope sensor, a magnetic sensor, a pressure sensor, or a temperature sensor.

The communication component 1116 is configured to facilitate wired or wireless communication between the UE1100 and other devices. The UE1100 may access a wireless network based on a communication standard, such as WiFi, 2G, or 3G, or a combination thereof. In an example embodiment, the communication component 1116 receives a broadcast signal or broadcast related information from an external broadcast management system via a broadcast channel. In an example embodiment, the communication component 1116 further includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example embodiment, the UE1100 may be implemented by at least one application specific integrated circuit (ASIC), a digital signal processor (DSP), a digital signal processing device (DSPD), a programmable logic device (PLD), a field programmable gate array (FPGA), a controller, a microcontroller, a microprocessor or other electronic components, and is configured to perform the above method.

FIG. 12 is a block diagram of a network device according to an embodiment of the present disclosure. For example, the network device 1200 may be provided as a network-side device. Referring to FIG. 12, the network device 1200 includes a processing component 1222, which further includes at least one processor, and a memory resource represented by a memory 1232, configured to store instructions executable by the processing component 1222, for example, an application program. The application program stored in the memory 1232 may include one or more modules each corresponding to a set of instructions. In addition, the processing component 1222 is configured to execute instructions to perform any method applied to the network side device in the foregoing method, for example, the method shown in FIG. 1.

The network device 1200 may further include a power component 1226 configured to perform power management of the network device 1200, a wired or wireless network interface 1250 configured to connect the network-device 1200 to a network, and an input/output (I/O) interface 1258. The network device 1200 may operate based on an operating system stored in the memory 1232, such as Windows Server™, Mac OS X™, Unix™, Linux™, Free BSD™, or the like.

In the embodiments provided by the present disclosure, the method provided by the embodiments of the present disclosure is introduced from the perspective of the network device and the UE. To implement the functions in the method provided in the embodiments of the present disclosure, the network device and the UE may include a hardware structure and a software module, so as to implement the functions in a form of the hardware structure, the software module, or a combination of the hardware structure and the software module. A function in the above functions may be performed by using a hardware structure, a software module, or a hardware structure plus a software module.

In the embodiments provided by the present disclosure, the method provided by the embodiments of the present disclosure is introduced from the perspective of the network device and the UE. To implement the functions in the method provided in the embodiments of the present disclosure, the network device and the UE may include a hardware structure and a software module, so as to implement the functions in a form of the hardware structure, the software module, or a combination of the hardware structure and the software module. A function in the above functions may be performed by using a hardware structure, a software module, or a hardware structure plus a software module.

An embodiment of the present disclosure provides a communication device. The communication device may include a transceiver module and a processing module. The transceiver module may include a sending module and/or a receiving module, the sending module is configured to implement a sending function, the receiving module is configured to implement a receiving function, and the transceiver module may implement the sending function and/or the receiving function.

The communication apparatus may be a terminal device (for example, the terminal device in the above method embodiments), or may be an apparatus in a terminal device, or may be an apparatus that can be matched with a terminal device for use. Alternatively, the communication apparatus may be a network device, an apparatus in a network device, or an apparatus that can be matched with a network device for use.

An embodiment of the present disclosure provides another communication device. The communications device may be a network device, a terminal device (for example, the terminal device in the above method embodiments), a chip, a chip system, or a processor that supports the network device in implementing the above method, or a chip, a chip system, or a processor that supports the terminal device in implementing the above method. Details can be referred from descriptions in the above method embodiments.

The communication device may include one or more processors. The processor may be a general-purpose processor, a special-purpose processor, or the like. For example, it may be a baseband processor or a central processing unit. The baseband processor may be configured to process a communication protocol and communication data, and the central processing unit may be configured to control a communication device (for example, a network side device, a baseband chip, a terminal device, a terminal device chip, a DU, or a CU), execute a computer program, and process data of the computer program.

Optionally, the communication device may further include one or more memories, where the one or more memories may store a computer program, and the processor executes the computer program, so that the communication device performs the method described in the above method embodiments. Optionally, the memory may further store data. The communication device and the memory may be separately disposed, or may be integrated together.

Optionally, the communication device may further include a transceiver and an antenna. The transceiver may be referred to as a transceiver unit, a transceiver, a transceiver circuit, or the like, and is configured to implement a transceiver function. The transceiver may include a receiver and a transmitter, where the receiver may be referred to as a receiver or a receiving circuit, and is configured to implement a receiving function; and the transmitter may be referred to as a transmitter or a sending circuit, and is configured to implement a sending function.

Optionally, the communication device may further include one or more interface circuits. The interface circuit is configured to receive the code instruction and transmit the code instruction to the processor. The processor runs the code instructions to cause the communication device to perform the method described in the above method embodiments.

The communication device is a terminal device (for example, the terminal device in the above method embodiments), and the processor is configured to perform any method shown in FIG. 1 to FIG. 4.

The communication device is a network device, and the transceiver is configured to perform any method shown in FIG. 5 to FIG. 7.

In an implementation, the processor may include a transceiver configured to implement receiving and sending functions. For example, the transceiver may be a transceiver circuit, an interface, or an interface circuit. The transceiver circuit, the interface, or the interface circuit for implementing the receiving and sending functions may be separate or integrated together. The transceiver circuit, the interface, or the interface circuit may be configured to read and write code/data, or the transceiver circuit, the interface, or the interface circuit may be configured to transmit or send a signal.

In an implementation, the processor may store a computer program, and the computer program runs on the processor, so that the communications apparatus can perform the method described in the above method embodiments. The computer program may be fixed in the processor, and in this case, the processor may be implemented by hardware.

In an implementation, the communication device may include a circuit, and the circuit may implement a function of sending, receiving, or communicating in the above method embodiments. The processors and transceivers described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, and the like. The processor and transceiver may also be fabricated with various IC process technologies, such as complementary metal oxide semiconductor (CMOS), n-type metal oxide semiconductor (NMOS), p-type metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or a terminal device (for example, the terminal device in the above method embodiments), but a scope of the communication device described in this disclosure is not limited thereto, and a structure of the communication device may not be limited. The communication device may be a standalone device or may be part of a larger device. For example, the communication device may include:
(1) an independent integrated circuit (IC), or chip, or chip system or subsystem;
(2) a set of one or more ICs, optionally, the set of ICs may also include a storage component configured to store data and a computer program;
(3) ASIC (application specific integrated circuit), e.g., a modem;
(4) modules that may be embedded within other devices;
(5) a receiver, a terminal device, an intelligent terminal device, a cellular phone, a wireless device, a handset, a mobile unit, an in-vehicle device, a network device, a cloud device, an artificial intelligence device, and the like;
(6) others, etc.

In the case that the communication device may be a chip or a chip system, the chip includes a processor and an interface. There may be one or more processors, and there may be more interfaces.

Optionally, the chip further includes a memory, and the memory is configured to store a necessary computer program and data.

Those skilled in the art may also understand that various illustrative logical blocks and steps listed in the embodiments of the present disclosure may be implemented by using electronic hardware, computer software, or a combination of the two. Whether such functionality is implemented by hardware or software depends on the particular application and design requirements of the overall system. Those skilled in the art may use various methods to implement the described functions for each specific application, but this implementation should not be understood as being beyond the protection scope of the embodiments of the present disclosure.

An embodiment of this disclosure further provides a reporting system, where the system includes the communication device used as the terminal device (for example, the user equipment in the above method embodiments) and the communication device used as the network device in the above embodiments.

The present disclosure further provides a readable storage medium having stored thereon instructions that, when executed by a computer, implement functions of any of the above method embodiments.

The present disclosure further provides a computer program product which, when executed by a computer, implements the functions of any one of the above method embodiments.

In the above embodiments, it may be implemented in whole or in part by software, hardware, firmware or any combination thereof. When implemented using software, it may be implemented in whole or in part in the form of a computer program product. The computer program product includes one or more computer programs. When the computer program is loaded and executed on a computer, the processes or functions according to the embodiments of the present disclosure are all or partially generated. The computer may be a general purpose computer, special purpose computer, computer network, or other programmable device. The computer program may be stored in a computer readable storage medium or transmitted from one computer readable storage medium to another computer readable storage medium, for example, the computer program may be transmitted from one website, computer, server or data center to another website, computer, server or data center in a wired (e.g., coaxial cable, optical fiber, digital subscriber line (DSL)) or wireless (e.g., infrared, wireless, microwave, etc.) manner. The computer-readable storage medium may be any available medium accessible by a computer or a data storage device such as a server or a data center that includes one or more available media. The usable medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

Those of ordinary skill in the art can understand that the numbers of the first, second and other numbers involved in the present disclosure are merely used to distinguish the description, and are not intended to limit the scope of the embodiments of the present disclosure, and also represent a sequence.

At least one of the present disclosure may also be described as one or more, and a plurality may be two, three, four or more, which is not limited in the present disclosure. In the embodiments of the present disclosure, for a technical feature, technical features in the technical feature are distinguished by “first,” “second,” “third,” “A,” “B,” “C,” and “D,” etc., and the technical features described by “first,” “second,” “third,” “A,” “B,” “C,” and “D” have no sequence in time or in size.

Other embodiments of the present disclosure will be readily apparent to those skilled in the art upon consideration of the specification and practice of the present disclosure disclosed herein. The present disclosure is intended to cover any variations, uses, or adaptations of the invention that follow the general principles of the invention and include common knowledge or conventional technical means in the art not disclosed in the present disclosure. The specification and embodiments are to be regarded as illustrative only, and the true scope and spirit of the present disclosure are indicated by the following claims.

It should be understood that the present disclosure is not limited to the precise structures already described above and shown in the accompanying drawings, and various modifications and changes may be made without departing from the scope thereof. The scope of the present disclosure is limited only by the appended claims.

1. A reporting method, performed by a user equipment (UE), comprising:
acquiring a capability request message sent by a network device; and
reporting capability information to the network device, wherein the capability information comprises at least one of:
first indication information indicating whether the UE supports a computing capability sharing function;
second indication information indicating whether the UE enables a-the_computing capability sharing function; or
a computing capability parameter of the UE.

2. The method according to claim 1, wherein the computing capability parameter of the UE comprises at least one of:
a base clock speed of a computing unit of the UE;
a cache of the computing unit of the UE;
a core count of the computing unit of the UE;
a bus speed of the computing unit of the UE; or
a ratio of sharable computing capability to total computing capability of the UE.

3. The method according to claim 1, wherein acquiring the capability request message sent by the network device comprises:
acquiring a UE Capability Enquiry message sent by the network device.

4. The method according to claim 1, wherein reporting the capability information to the network device comprises:
reporting UE Capability information to the network device.

5. The method according to claim 1, further comprising:
acquiring an enquiry request message sent by the network device, wherein the enquiry request message comprises at least one of:
first enquiry information enquiring whether computing capability of the UE is available to be shared to the network device; or
second enquiry information enquiring a time when computing capability of the UE is available to be shared to the network device.

6. The method according to claim 5, wherein acquiring the enquiry request message sent by the network device comprises:
acquiring a UE Information Request message sent by the network device.

7. The method according to claim 5, further comprising:
sending a response message to the network device; wherein the response message comprises at least one of:
a third indication information indicating whether the computing capability of the UE is available to be shared to the network device; or
time information indicating the time when the computing capability of the UE is available to be shared to the network device.

8. The method according to claim 7, wherein sending the response message to the network device comprises:
sending the response message to the network device based on a computing task of the UE.

9. The method according to claim 7, wherein sending the response message to the network device comprises:
sending a UE Information Response message to the network device.

10. A method for reporting, performed by a network device, comprising:
sending a capability request message to a user equipment (UE); and
acquiring capability information reported by the UE, wherein the capability information comprises at least one of:
first indication information indicating whether the UE supports a computing capability sharing function;
second indication information indicating whether the UE enables thea computing capability sharing function; or
a computing capability parameter of the UE.

11. The method according to claim 10, wherein the computing capability parameter of the UE comprises at least one of:
a base clock speed of a computing unit of the UE;
a cache of the computing unit of the UE;
a core count of the computing unit of the UE;
a bus speed of the computing unit of the UE; or
a ratio of sharable computing capability to total computing capability of the UE.

12. The method according to claim 10, wherein sending the capability request message to the UE comprises:
sending a UE Capability Enquiry message to the UE.

13. The method according to claim 10, wherein acquiring the capability information reported by the UE comprises:
acquiring UE Capability Information reported by the UE.

14. The method according to claim 10, further comprising:
sending an enquiry request message to the UE, wherein the enquiry request message comprises at least one of:
first enquiry information enquiring whether computing capability of the UE is available to be shared to the network device; or
second enquiry information enquiring a time when computing capability of the UE is available to be shared to the network device.

15. The method according to claim 14, wherein sending the enquiry request message to the UE comprises:
sending a UE Information Request message to the UE.

16. The method according to claim 14, further comprising:
acquiring a response message sent by the UE, wherein the response message comprises at least one of:
a third indication information indicating whether the computing capability of the UE is available to be shared to the network device; or
time information indicating the time when the computing capability of the UE is available to be shared to the network device;
wherein acquiring the response message sent by the UE comprises:
acquiring a UE Information Response message sent by the UE;
wherein the method further comprises:
using the computing capability of the UE when the computing capability of the UE is available to be shared to the network device.

17. (canceled)

18. (canceled)

19. A reporting apparatus, comprising:
a processor and a memory, wherein the memory stores a computer program, and the processor executes the computer program stored in the memory to cause the devicereporting apparatus to:
acquire a capability request message sent by a network device; and
report capability information to the network device, wherein the capability information comprises at least one of:
first indication information indicating whether a User Equipment (UE) supports a computing capability sharing function;
second indication information indicating whether the UE enables the computing capability sharing function; or
a computing capability parameter of the UE.

20. A reporting pparatus, comprising:
a processor and a memory, wherein the memory stores a computer program, and the processor executes the computer program stored in the memory to cause the reporting apparatus to perform the method according to claims 10.

21. (canceled)

22. (canceled)

23. (canceled)

24. (canceled)

25. A non-transitory_computer-readable storage medium storing an instruction, and when the instruction is executed, the method according to claim 1 is implemented.

26. A non-transitory_computer-readable storage medium storing an instruction, and when the instruction is executed, the method according to claim 10 is implemented.
